(19) United States
(12) Patent Application Publication
(10) Pub. No.: US 2013/0276717 A1
(43) Pub. Date: Oct. 24, 2013

(54) HARNESS

(71) Applicant: Victoria A. Fuller, Los Angeles, CA (US)

(72) Inventor: Victoria A. Fuller, Los Angeles, CA (US)

(21) Appl. No.: 13/795,934

(22) Filed: Mar. 12, 2013

Related U.S. Application Data
(60) Provisional application No. 61/635,585, filed on Apr. 19, 2012.

(51) Int. Cl. A01K 27/00

(52) U.S. Cl. CPC A01K 27/004
USPC 119/794

(57) ABSTRACT

A harness for pets including a leash. The leash includes a selectably removable decorative handle. The harness includes a leash retraction device coupled to the leash and configured to retract the leash into a retraction body. The leash retraction device includes a retraction brake system. The harness includes a pocket substantially enclosing the retraction body.

### CROSS-REFERENCE TO RELATED APPLICATIONS

This invention claims priority, under 35 U.S.C. §120, to the U.S. Provisional Patent Application No. 61/635,585 by Fuller filed on 19 Apr. 2012, which is incorporated by reference herein in its entirety.

### BACKGROUND OF THE INVENTION

1. Field of the Invention

The present invention relates to harnesses, specifically a pet harness having a retractable leash.

2. Description of the Related Art

A harness is commonly worn in conjunction with a collar and used as an alternative for leash attachment. While a collar only encircles the neck, harnesses have a loop that surrounds the torso as well, with connecting straps between them for reinforcement. This design allows for distribution of force which may prevent choking and a lower chance of slipping out than may be possible with only a collar. Harness usage is growing in popularity among many pet owners—especially for those with smaller breed dogs.

Recently, pet clothing frequently sports a properly-placed buttonhole for hooking a leash to the harness worn under the garment. Dog harnesses that are designed to look like clothes are available. These items are designed to reduce the stress placed on a small dogs neck while walking on a lead.

A dog harness is piece of equipment for dogs, generally similar to harness tack for horses. There are various designs depending on the type of use, whether it be for assistance to a disabled person, hauling a cart or sled, or pulling a human being, such as in skijoring or pulka. Harnesses are also commonly worn by non-working dogs.

Some improvements have been made in the field. Examples of references related to the present invention are described below in their own words, and the supporting teachings of each reference are incorporated by reference herein:

U.S. Pat. No. 7,461,615, issued to Albright, discloses a harness with a retractable leash secured on the harness so that it remains in a fixed location on an animal's back, making it comfortable for the animal, yet always accessible for a user. The animal can freely move about without being encumbered by the leash, and the leash remains easily accessible by the user on the animal's back, even when not in use. A locking feature will maintain the leash to a predetermined length when the leash is being used.

U.S. Pat. No. 6,694,923, issued to Fouche, discloses a harness assembly (24 surrounding an animal's body around the neck, across the back, upon the underside and around the animal's chest. The harness assembly (24) includes a shoulder connecting member (28) having an upward extending, quick connect plug (34); a neck band (46) encircling the animal's neck and that is attached to the shoulder connecting member (28); a body band (50) encircling the animal behind its front legs and that attaches to the shoulder connecting member (28); and a chest member (54) connected to the neck and body. A stand-up leash (64), which is attached to the plug (34), normally remains in an upright position permitting a person walking the animal to comfortably grasp the leash (64) with a hand grip (88). A quick connect coupling (74) interfaces with the plug (34) for removing or replacing the stand-up leash (64) from the harness assembly (24). The leash (64) also has an extension (90) for lengthening which permits the animal increased freedom of movement.

U.S. Pat. No. 5,471,953, issued to Sporn, discloses a leash-controllable dog harness adapted to inhibit a dog from straining against a leash held by an individual walking the dog and inducing the dog to come to a halt or to walk at a pace acceptable to the leash holder includes a shoulder junction provided with an openable loop which overlies the dog's shoulder intermediate its right and left forelegs, and a chest junction which lies adjacent the dog's chest intermediate the foreleg crotches. Extending between the shoulder and chest junctions on opposite sides of the dog are a pair of straps whose lengths are adjustable to accommodate the harness to the dog. Extending from the chest junction are a pair of restraint cables, one passing through the right foreleg crotch and then through the loop of the shoulder junction to terminate in a first ring, the other passing through the left foreleg crotch and then through the same loop to terminate in a second ring. Both rings are coupled to the leash whereby when the leash is strained, the cables are concurrently caused to ride up the respective crotches to impose pressure on the sensitive foreleg pits. This action induces the dog to seek to relieve the pressure by slowing down its pace or coming to a halt, depending on the degree of pressure applied to the pits.

U.S. Pat. No. 8,001,933, issued to Robley et al., discloses a retractable pet leash apparatus having a hollow casing, a spool which is mounted for rotation within the casing and which has a pair of sides, a leash which is coiled on the spool in a retracted position and which is extendable through an aperture formed in a wall of the hollow casing upon application of a force, a spring means which is disposed within the hollow housing and which is engageable with the spool for biasing the spool for rotation to retract the leash into the hollow casing. A brake device is engageable with the spool for selectively fixing a free end of the leash at a predetermined distance from the casing and enabling retraction and extension of the leash relative to the hollow casing. The invention also provides a pocket on the exterior surface of the casing for receiving pet identification or immunization tag and a carrying ring.

U.S. Patent Application Publication No.: 2005/0211189, by Price, discloses an integrated pet leash comprising a pet restraint, handle, retractors fastened to the outer side of the collar, and flexible elongated members. The flexible elongated members are coupled between the ends of the handle and the retractors. The retractors exert a force on the flexible elongated members toward the restraint. Additionally, the handle may include a detachable fastener to lock the collar-leash to poles, fence posts, parking meters, and the like.

The inventions heretofore known suffer from a number of disadvantages which include being limited in use, being difficult to use, being limited in interchangeability, being bulky, being expensive, being ineffective, being inefficient, being cumbersome to use, being undesirable in appearance, being uncomfortable for the pet/owner, not providing appropriate control of the pet, not being washable, requiring the owner to search for a leash before operation thereof, being likely to be caught on objects, not being customizable in appearance, being inappropriate for continuous wear by the animal, being dangerous to the pet/owner, causing fear in the animal, appearing like a leash when not in use, and being expensive.

What is needed is a harness that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available harnesses. Accordingly, the present invention has been developed to provide a pet harness including a retractable and selectably interchangeable leash.

According to one embodiment of the invention, there is a harness for pets that may include a leash. The leash may include a selectably removable decorative handle. The harness may include a leash retraction device that may be coupled to the leash and may be configured to retract the leash into a retraction body. The leash retraction device may include a retraction brake system. The retraction brake system may include a friction member that may be disposed about the leash and may be configured to slowly retract the leash therethrough. The retraction brake system may include a friction device that may be disposed about the leash and may be configured to slowly retract the leash once the leash retracts to a predetermined distance. The retraction brake system may include a stop device that may be disposed about the leash and may be configured to stop retraction of the leash once the leash retracts to a predetermined distance; wherein the stop device, once activated, may release the leash to completely retract into the leash retraction device.

The harness may include a pocket that may be substantially enclosing the retraction body. The pocket may include a first aperture, which may be sized smaller than the retraction body, wherein the leash may extend through the first aperture. The pocket may include a second aperture that may be configured to permit selective removal of the retraction body from the pocket. The second aperture may be disposed opposite of the first aperture. The second aperture may include a sealing device that may be configured to selectably seal the second aperture. The pocket may be disposed on a top surface of a vest. The vest may include a vest body member configured to receive a pet body. The vest body member may include a first aperture and a second aperture that each may be configured to receive a front leg of a pet. The vest body member may include a first end and a second end that may be configured to selectably couple together about a back region of a pet.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a side perspective view of a harness in use in a deployed mode, according to one embodiment of the invention, according to one embodiment of the invention;

FIG. 2 is a side perspective view of a harness in use in an un-deployed and disguised mode, according to one embodiment of the invention;

FIG. 3 is a top perspective view of a pocket and a leash retraction device of a harness, according to one embodiment of the invention;

FIG. 4 is a side perspective view of a harness, according to one embodiment of the invention;

FIG. 5 is a top plan cross-sectional view of a leash retraction device, according to one embodiment of the invention;

FIG. 6 is a top plan cross-sectional view of a leash retraction device, according to one embodiment of the invention;

FIG. 7 is a top plan cross-sectional view of a leash retraction device, according to one embodiment of the invention; and

FIG. 8 is a side perspective view of a harness, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

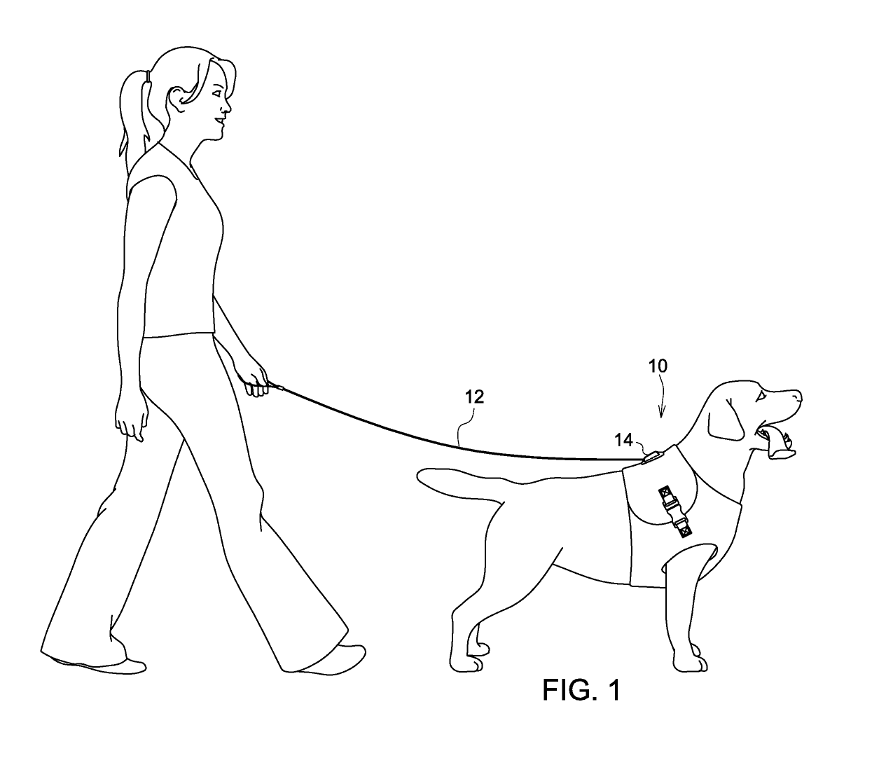

FIG. 1 is a side perspective view of a harness, according to one embodiment of the invention, according to one embodiment of the invention. There is shown a harness 10 including a leash 12 and a leash retraction device 14.

The illustrated harness 10 is configured to be worn about a chest region wrapping about a back region of a pet. The harness 10 is configured to surround a torso of a pet allowing for distribution of force, which prevents choking and also has a lower chance of slipping off the pet, than with only a collar. The harness 10 includes a leash retraction device 14 disposed within a pocket structure of the harness and coupled to a leash 12. The leash retraction device 14 is configured to retract the leash 12 therein through an aperture in the pocket that disposed in a rearward portion of the pocket. The illustrated leash retraction device 14 is disposed about a back region of a pet; wherein the disposition of the leash retraction device 14 is configured to provide a distribution of force applied to the pet when pulling back on the leash 12.

In one embodiment, there is a pet harness with a hidden and/or retractable leash. When the animal is wearing the harness, it looks like a decorated article of clothing or harness without a leash. The owner is able to grab hold of a decorative structure/member on the harness and pull. The decorative structure is selectably coupled to a retracted leash having a leash retraction device hidden inside a pocket on the harness. As the owner pulls the decorative structure, the leash retracts and the decorative structure becomes the handle of the leash. The decorative structure may be selectably removable from the leash, such that the owner may be able to replace the decorative structure with another decorative structure, such as but not limited to being, for matching a social occasion and/or the outfit of the owner. There may be a kit including a harness and a plurality of varied decorative structures. The leash retraction system is selectably removable from the pocket of the harness so that the harness may be washed without damaging the leash retraction system.

In one non-limiting embodiment, the hidden retraction system is held in place by a compression strap, a cover, a coupling device, or the like instead of a pocket. The retraction system may be disguised in a manner similar to the decorative structure. There may be a coupling device on the harness that is adjacent the retraction system that couples to the decorative structure when retracted, thereby securing the decorative structure in a fixed position and/or orientation. It may be that the retraction device is not completely hidden, especially wherein at least a portion of the retraction system/device is decorated and/or a portion thereof is covered by the decorative structure when retracted.

In one non-limiting embodiment, there is a decorative structure that includes visual leash handle elements that are retracted out of view when fully retracted. It may be that the leash may include a plurality of decorative structures coupled thereto simultaneously, either at a coupling point that can accept multiple members or wherein there are a plurality of coupling points. A decorative structure may also include selectably changeable structure (pivoting joints, folding members, coupling bands, etc.) wherein when retracted then functional handle/loop structure may be created so that the handle is easier to use, while prior to retraction that structure can be folded/etc. back into its more purely decorative state before/after allowing the leash to retract.

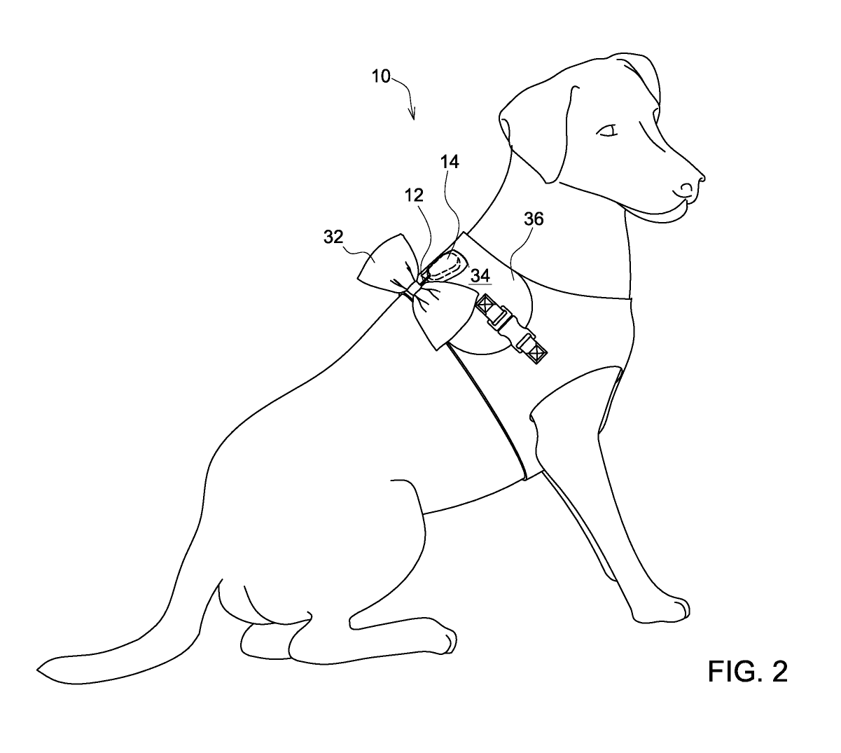

FIG. 2 is a side perspective view of a harness, according to one embodiment of the invention. There is shown a harness 10 including a leash 12, a leash retraction device 14, and a vest 36.

The illustrated harness 10 is configured for use with pets, such as taking them for walks or securing them to a seat of a car. The harness 10 includes a leash 12 configured to selectably retract and pull out therefrom. The illustrated leash 12 includes a selectably removable decorative handle/structure/member 32. The illustrated selectably removable decorative handle 32 is a ribbon or a bow. The selectable removable decorative handle 32 may be, but is not limited to, a crown, a bejeweled loop, a baseball, a pad, a hat, a bone, a bow, a face, a crest, a holiday themed item, a mane, a brush, an animal replica/simulacrum/caricature, and the like and combinations thereof.

The harness 10 includes a leash retraction device 14 coupled to the leash 12 and configured to retract the leash 12 into a retraction body. The harness 10 includes a vest 36 configured to be secured about a torso region of a pet. The illustrated leash retraction device 14 is disposed on a top surface 34 of the vest 36; thereby providing a distribution of force applied to the torso region of the pet when pulling back on the leash 12

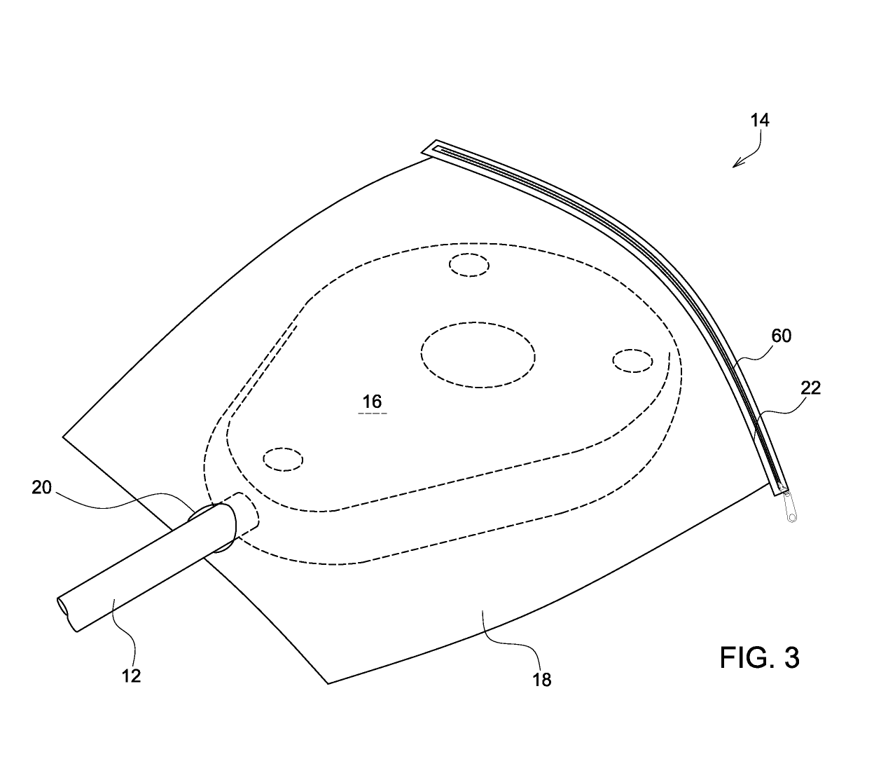

FIG. 3 is a top perspective view of a pocket and a leash retraction device of a harness, according to one embodiment of the invention. There is shown a leash retraction device 14 having a retraction body 16.

The illustrated leash retraction device 14 is configured to be coupled to a leash 12. The leash retraction device is configured to retract the leash 12 into a retraction body 16. The retraction body 16 is configured to secure and store the mechanical components of the retraction mechanism to release and retract the leash 12 therefrom. The leash retraction device 14 is disposed in a pocket 18 of a harness. The pocket is configured to substantially enclose the retraction body 16.

The illustrated pocket 18 includes a first aperture 20, which is sized smaller than the retraction body 16, wherein the leash 12 extends through the first aperture 20. The pocket 18 includes a second aperture 22 configured to permit selective removal of the retraction body 16 from the pocket 18. The second aperture 22 is disposed opposite of the first aperture 20. The second aperture 22 includes a sealing device 60 (illustrated as a zipper), such as but not limited to a zipper, snap(s), button(s), clip(s), hook-and-loop structures, Velcro, and the like and combinations thereof, configured to selectably seal the second aperture 22. The pocket is configured to be disposed on a top surface of a vest.

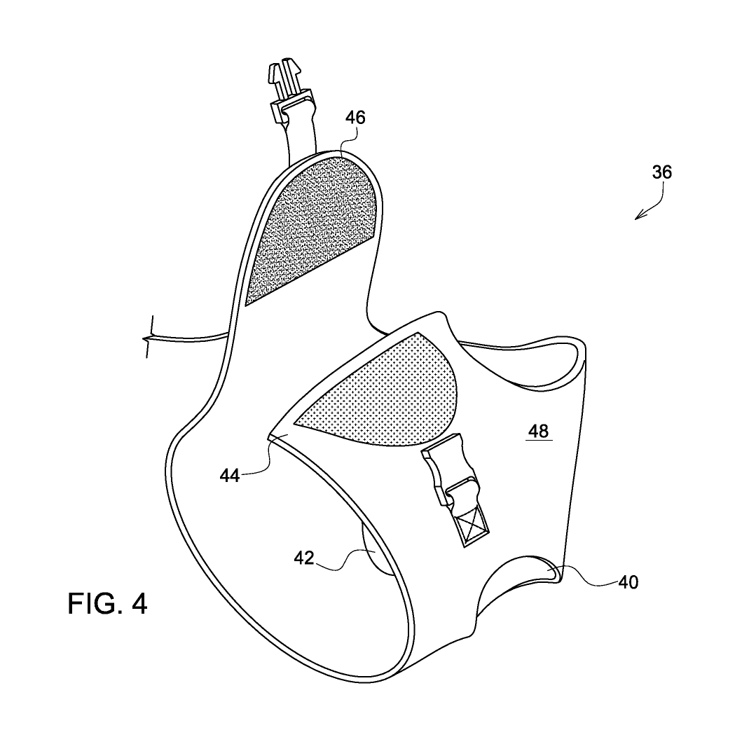

FIG. 4 is a side perspective view of a harness, according to one embodiment of the invention. There is shown a vest 36 including a vest body member 48, a first aperture 40, a second aperture 42, a first end 44, and a second end 46.

The illustrated vest 36 includes a vest body member 48 configured to receive a pet body. The vest body member 48 is designed with a stylish and fashionable material. The vest body member 48 includes a first aperture 40 and a second aperture 42 each configured to receive a front leg of a pet. The vest body member 48 includes a first end 44 and a second end 46 configured to selectably coupled together about a back region of a pet. The illustrated first end 44 and the illustrated second end 46 include corresponding coupling members configured to couple together to secure the vest 36 about a torso region of a pet. The corresponding coupling members may include a hook and loop coupling device, hooks, loops, Velcro, magnets, clips, snaps, magnets, buttons, zippers, etc.

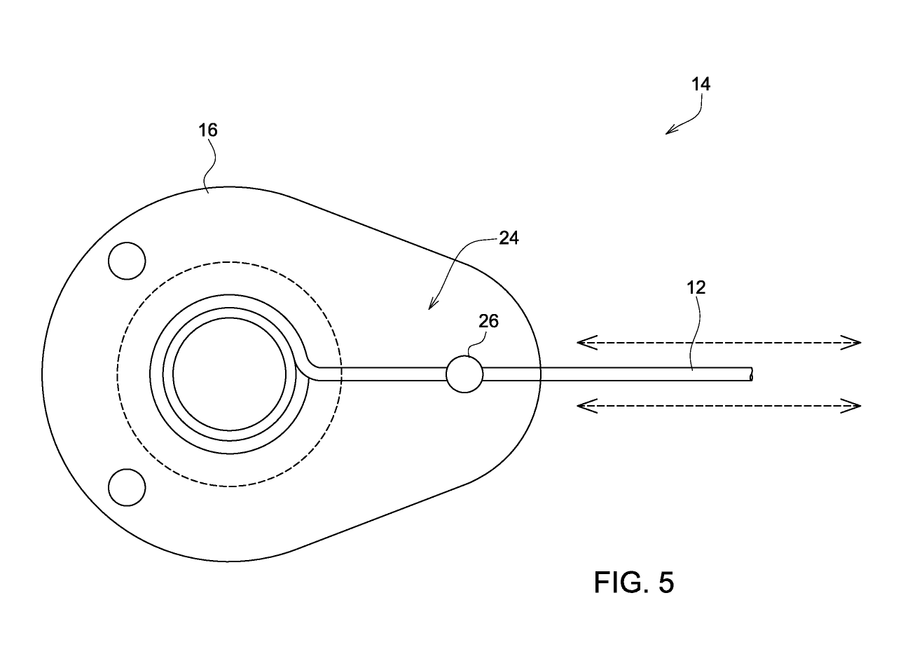

FIG. 5 is a top plan cross-sectional view of a leash retraction device, according to one embodiment of the invention. There is shown a leash retraction device 14 including a retraction body 16, and a retraction brake system 24 having a friction member 26.

The illustrated leash retraction device 14 is configured to be disposed about a top surface of a vest, thereby providing a harness for a pet. The leash retraction device 14 includes a leash 12 configured to couple to a handle for a user to manipulate and control a pet coupled thereto. The leash retraction device 14 is configured to retract the leash 12 into a retraction body 16.

The illustrated leash retraction device 14 includes a retraction brake system 24 configured to slow down the retraction of the leash 12 into the retraction body 16. The illustrated retraction brake system 24 includes a friction member 26 disposed about the leash 12 and configured to slow down the retraction of the leash 12 therethrough. The friction member 26 may include an aperture disposed therethrough configured to sized and shaped slightly larger than the leash 12. The leash 12 may be disposed through the aperture of the friction member 26; wherein the friction member contacts the exterior surface of the leash 12 when being retracted into the retraction body 16.

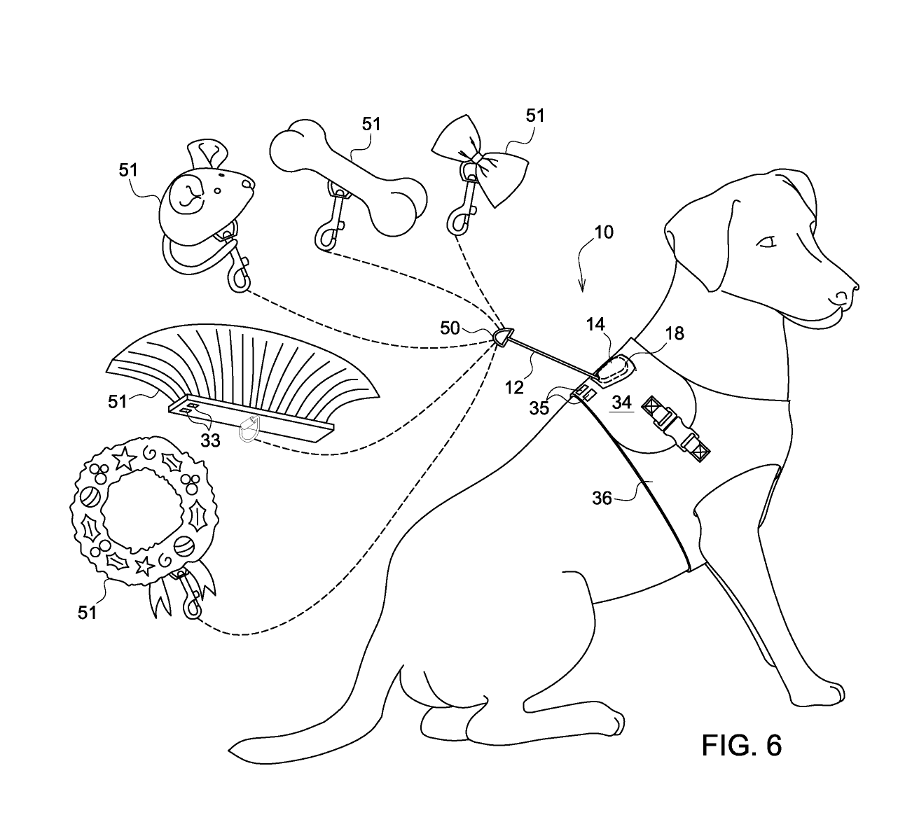

FIG. 6 is a side perspective view of a harness, according to one embodiment of the invention. There is shown a harness 10 including a vest 36 having a leash 12, a leash retraction device 14, and a selectably coupleable handle member 50 configured to couple to one or more of a plurality of decorative handles 51 that may be present in a kit and/or may be purchasable separately.

The illustrated harness 10 is configured to secure about a pet for travel. The harness 10 includes a leash 12. The harness 10 includes a leash retraction device 14 coupled to the leash 12 and configured to retract the leash 12 therein. The harness 10 includes a pocket 18 configured to substantially enclose the leash retraction device 14. The pocket 18 is disposed on a top surface 34 of a vest 36.

There may be one or more selectably removable decorative handles 51 configured to selectably couple to a selectably coupleable handle member 50 (illustrated as a D-ring coupled to an end of the leash) of the leash 12. The selectably coupleable handle member may include one or more devices/structures configured to mate with and/or couple to and/or be a mounting point for associated coupling structure(s) of the decorative handles, such as but not limited to rings, snaps, magnets, hook-and-loop structures, buttons, clips, loops, ties, and the like and combinations thereof. The illustrated decorative handles include a bow, a bone, a plush mouse, a Mohawk-styled mane, and a Christmas wreath. The Mowhawk-styled mane includes a plurality of securing devices 33 configured to couple with matching securing devices 35 disposed on the harness adjacent the pocket, such that when the decorative handle member is in a retracted mode, the user can fix the position and orientation of the decorative member 51 on the back of the animal, generally so that a particular appearance effect in achieved and maintained as the animal moves about. The securing device(s) 35 may include one or more devices/structures configured to mate with and/or couple to and/or be a mounting point for associated securing device(s) 33 of the decorative handles, such as but not limited to rings, snaps, magnets, hook-and-loop structures, buttons, clips, loops, ties, and the like and combinations thereof.

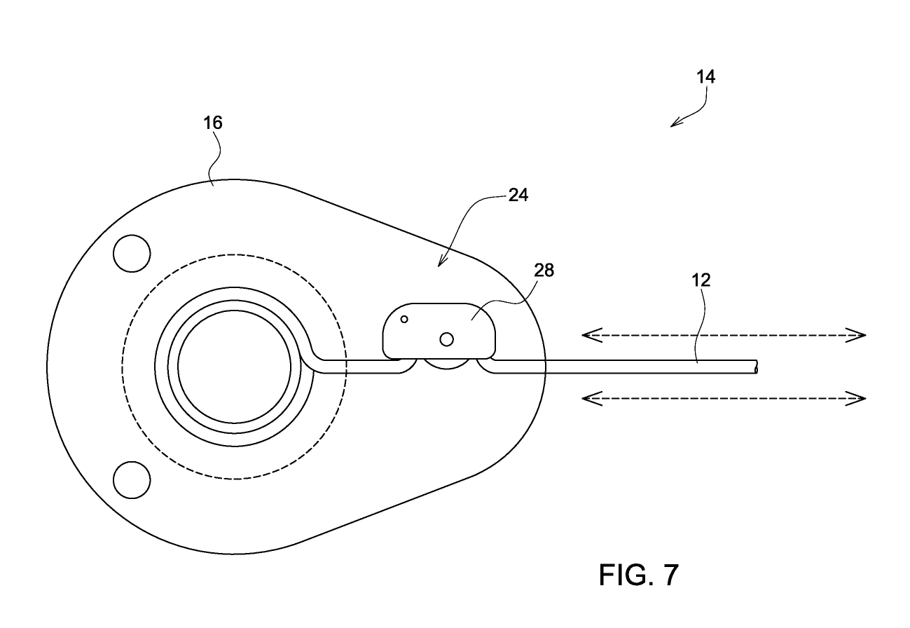

FIG. 7 is a top plan cross-sectional view of a leash retraction device, according to one embodiment of the invention. There is shown a leash retraction device 14 including a retraction body 16, and a retraction brake system 24 having a friction device 28.

The illustrated leash retraction device 14 is configured to be disposed about a top surface of a vest, thereby providing a harness for a pet. The leash retraction device 14 includes a leash 12 configured to couple to a handle for a user to manipulate and control a pet coupled thereto. The leash retraction device 14 is configured to retract the leash 12 into a retraction body 16.

The illustrated leash retraction device 14 includes a retraction brake system 24 configured to slow down the retraction of the leash 12 into the retraction body 16, once the leash 12 retracts a predetermined distance. The illustrated retraction brake system 24 includes a friction device 28, such as a brake system, disposed about the leash 12 and configured to slow down the retraction of the leash 12 therethrough once the leash 12 retracts to a predetermined distance. The illustrated friction device 28 is configured to include a pair of friction pads configured to slow down the retraction of the leash 12 once the leash has retracted into the retraction body 16 at a predetermined distance.

Non-limiting examples of a retraction braking system may be a braking device as described in U.S. Patent Publication No.: 2013/0008392; or a braking mechanism as described in U.S. Pat. No. 8,251,020, which are incorporated for their supporting teachings herein by reference.

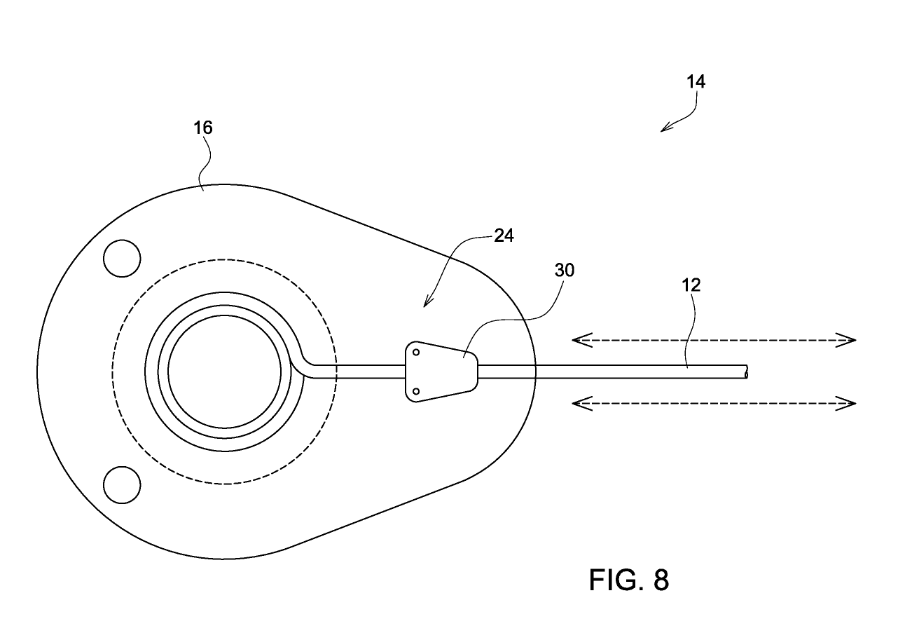

FIG. 8 is a top plan cross-sectional view of a leash retraction device, according to one embodiment of the invention. There is shown a leash retraction device 14 including a retraction body 16, and a retraction brake system 24 having a stop device 30.

The illustrated leash retraction device 14 is configured to be disposed about a top surface of a vest, thereby providing a harness for a pet. The leash retraction device 14 includes a leash 12 configured to couple to a handle for a user to manipulate and control a pet coupled thereto. The leash retraction device 14 is configured to retract the leash 12 into a retraction body 16.

The illustrated leash retraction device 14 includes a retraction brake system 24 configured to stop the retraction of the leash 12 into the retraction body 16, once the leash 12 retracts a predetermined distance. The illustrated retraction brake system 24 includes a stop device 30, such as a brake system, disposed about the leash 12 and configured to stop the retraction of the leash 12 therethrough once the leash 12 retracts to a predetermined distance. The illustrated stop device 30 is disposed about the leash 12 and configured to stop retraction of the leash 12 once the leash retracts to a predetermined distance. The stop device 30, once activated, releases the leash 12 to completely retract into the leash retraction device 14.

Non-limiting examples of a retraction braking system having a stop device may be a stop button as described in U.S. Pat. No. 8,336,505; or a catch stop as described in U.S. Patent Publication No.: 2007/0022975, which are incorporated for their supporting teachings herein by reference.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the figures illustrate a particularly shaped harness with particular coupling devices, it is understood that the shape of the harness may vary greatly will still performing its intended function and the coupling devices that may be used in conjunction with the harness are plethoric.

Additionally, although the figures illustrate particular decorative members/handles, it is understood that the variety of decorative handles are plethoric.

It is expected that there could be numerous variations of the design of this invention. An example is that the harness may be a webbing of materials instead of a vest.

Finally, it is envisioned that the components of the device may be constructed of a variety of materials, including but not limited to textiles, metals, ceramics, fibers, wood, plastics, rubbers, minerals, and the like and combinations thereof.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A harness for pets, comprising:
a) a leash;
b) a leash retraction device coupled to the leash and configured to retract the leash into a retraction body; and
c) a pocket substantially enclosing the retraction body and including:
c1) a first aperture, sized smaller than the retraction body, wherein the leash extends through the first aperture; and
c2) a second aperture configured to permit selective removal of the retraction body from the pocket.

2. The harness of claim 1, wherein the second aperture is disposed opposite of the first aperture.

3. The harness of claim 1, wherein the leash retraction device includes a retraction brake system.

4. The harness of claim 3, wherein the retraction brake system includes a friction member disposed about the leash and configured to slowly retract the leash therethrough.

5. The harness of claim 3, wherein the retraction brake system includes a friction device disposed about the leash and configured to slowly retract the leash once the leash retracts to a predetermined distance.

6. The harness of claim 3, wherein the retraction brake system includes a stop device disposed about the leash and configured to stop retraction of the leash once the leash retracts to a predetermined distance; wherein the stop device, once activated, releases the leash to completely retract into the leash retraction device.

7. The harness of claim 1, wherein the leash includes a decorative handle.

8. The harness of claim 7, wherein the decorative handle is selectably removable.

9. The harness of claim 1, wherein the pocket is disposed on a top surface of a vest.

10. The harness of claim 9, wherein the vest includes:
a) a vest body member configured to receive a pet body;
b) a first aperture;
c) a second aperture; wherein each of the first aperture and the second aperture are configured to receive a front leg of a pet;
d) a first end; and
e) a second end configured to selectably couple to the first end about a back region of a pet.

11. The harness of claim 1, wherein the second aperture includes a sealing device configured to selectably seal the second aperture.

12. A harness for pets, comprising:
a) a leash;
b) a leash retraction device coupled to the leash and configured to retract the leash into a retraction body; wherein the leash retraction device includes a retraction brake system; and
c) a pocket substantially enclosing the retraction body and including:
c1) a first aperture, sized smaller than the retraction body, wherein the leash extends through the first aperture; and
c2) a second aperture configured to permit selective removal of the retraction body from the pocket.

13. The harness of claim 12, wherein the second aperture is disposed opposite of the first aperture.

14. The harness of claim 13, wherein the retraction brake system includes a friction member disposed about the leash and configured to slowly retract the leash therethrough.

15. The harness of claim 14, wherein the retraction brake system includes a friction device disposed about the leash and configured to slowly retract the leash once the leash retracts to a predetermined distance.

16. The harness of claim 15, wherein the retraction brake system includes a stop device disposed about the leash and configured to stop retraction of the leash once the leash retracts to a predetermined distance; wherein the stop device, once activated, releases the leash to completely retract into the leash retraction device.

17. The harness of claim 16, wherein the pocket is disposed on a top surface of a vest.

18. The harness of claim 18, wherein the vest includes:
a) a vest body member
b) a first aperture;
c) a second aperture; wherein each of the first aperture and the second aperture are configured to receive a front leg of a pet;
d) a first end; and
e) a second end configured to selectably couple to the first end about a back region of a pet.

19. The harness of claim 18, wherein the second aperture includes a sealing device configured to selectably seal the second aperture.

20. A harness for pets, comprising:
a) a leash;
b) a leash retraction device coupled to the leash and configured to retract the leash into a retraction body; wherein the leash retraction device includes a retraction brake system; wherein the retraction brake system includes a friction member disposed about the leash and configured to slowly retract the leash therethrough; and
c) a pocket substantially enclosing the retraction body and including:
c1) a first aperture, sized smaller than the retraction body, wherein the leash extends through the first aperture; and
c2) a second aperture configured to permit selective removal of the retraction body from the pocket; wherein the second aperture is disposed opposite of the first aperture; wherein the second aperture includes a sealing device configured to selectably seal the second aperture; wherein the pocket is disposed on a top surface of a vest; wherein the vest includes:
i) a vest body member
ii) a first aperture;
iii) a second aperture; wherein each of the first aperture and the second aperture are configured to receive a front leg of a pet;
iv) a first end; and
v) a second end configured to selectably couple to the first end about a back region of a pet.
